(19) United States
(12) Patent Application Publication
(10) Pub. No.: US 2004/0118829 A1
(43) Pub. Date: Jun. 24, 2004

(54) Safety structure of a clip type electric hot pot

(76) Inventor: Chia-Hsiung Wu, Taipei (TW)

Correspondence Address: Chia-Hsiung Wu, P.O. Box No. 6-57, Chung-Ho, Taipei, 235, TW

(21) Appl. No.: 10/326,552

(22) Filed: Dec. 23, 2002

(51) Int. Cl. H05B 3/08

(52) U.S. Cl. 219/436; 219/541

(57) ABSTRACT

A safety structure of a clip type electric hot pot, more particularly, an electric hot pot to be used for small hot pot cooking, mainly includes a pot; the bottom portion of the pot has a heating device with an adjustable power and is tightly sealed by a bottom tray; through a conduction tab, the heating device conducts the electricity inwardly; the conduction tab on the bottom tray corresponds downwardly to a conduction terminal disposed on a conduction seat for conducting the electricity via contact so as to form a safe and clip type hot pot structure.

### BACKGROUND OF THE INVENTION

1) Field of the Invention

The present invention relates to a safety structure of a clip type electric hot pot, more particularly, to a hot pot to be used for small hot pot cooking; the present invention mainly uses a clipping method to conduct the electricity and has a tightly sealed bottom tray disposed inside a pot for covering a heating device. The bottom tray conducts the electricity outwardly through a conduction tab according to the power selected respectively; therefore, the pot itself is a clip type unit with the functions of providing adjustable heat, safe application and being easy for cleansing.

2) Description of the Prior Art

For regular small-sized hot pot cooking, the most available equipment uses gas or electromagnetic stove for heating. However, this kind of heating method is dangerous in a certain way; in addition, the magnetic wave might be harmful to the human beings; furthermore, the general electric heating method via thermal resistance is subjected to deterioration, not easy for cleansing and its temperature is hard to control.

### SUMMARY OF THE INVENTION

The present invention particularly designs a pot to be completely sealed, have a safe clip type electric conduction and an adjustable heating power; the achieved advantages include convenience for cleansing, displaying and moving. The applicable heat device is not subjected to aging but can be used through direct current for facilitating an outdoor application. It works at a low temperature thereby assuredly increasing the useful life of each relative and assembled element. Additionally, the heating device has thermostatic control and rapid heating-up time such that the present invention is capable of achieving convenient and safe application effects.

To enable a further understanding of the technical contents of the present invention, the brief description of the drawings is followed by the detailed description of a preferred embodiment.

### BRIEF DESCRIPTION OF THE DRAWINGS

FIG. 1 is a schematic drawing of the relationship among all the elements at the bottom portion of a pot of the present invention.

FIG. 2 is a planar and schematic drawing of the bottom portion of the pot of the present invention.

FIG. 3 is a schematic drawing of the installation of the present invention.

### DETAILED DESCRIPTION OF THE PREFERRED EMBODIMENTS

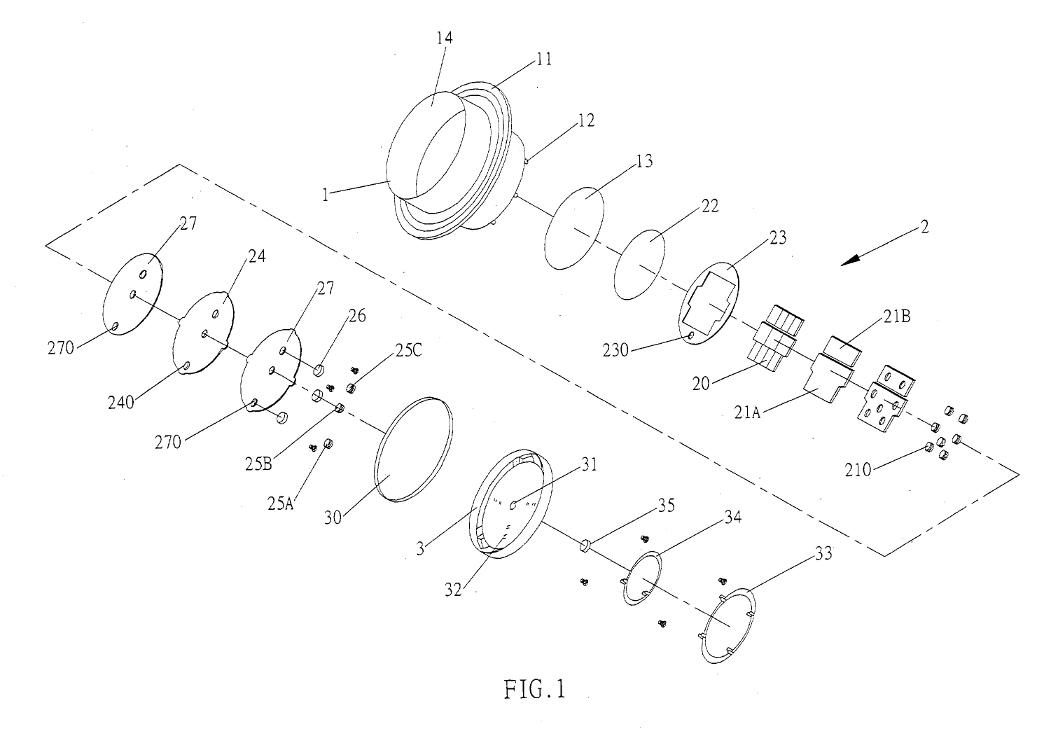

Referring to FIG. 1, a pot (1) of the present invention has an annular circumference (11) disposed on a shoulder portion thereof; the bottom flat plane is affixed with a thermal conduction insulating layer (13) with assembling screw posts (12) disposed radially; the entire pot (1) butt joints a heating device (2); a bottom tray (3) oppositely seals and assembles the bottom portion of the heating device (2) and the bottom portion of the pot (1) via a waterproof washer (30); wherein the heating device (2) is a heat generator (20) made of a plurality of porcelain resistances with positive temperature coefficient firmly framed by an insulation fixing plate (23) and arranged in piece-shapes. A negative conduction plate (22) is disposed relative to the upper aspect of the heat generator (20); the lower aspect thereof is electrically conducted via electrode plates (21A, 21B) with an adjustable power; the electrode plates (21A, 21B) are disposed with elastic press connection elements (210) through a division insulation plate (27) of a press plate (24) to press the electrode plates (21A, 21B) upwardly; that synchronously presses the piece-shaped heat generator (20) thereby further transmitting the elastic pressing force to the negative electrode plate (22) at the upper aspect and pressing the bottom portion of the entire pot (1) to conduct hot temperature through pressing; furthermore, the lower aspect thereof presses and contacts the press plate (24) which is insulated by an insulation plate (27) downwardly.

For respectively conducting electricity to the electrode plates (21A, 21B), a center through hole (31) is disposed at the center and a plurality of penetrating holes (32) are disposed on the periphery of the bottom tray (3); annular conduction tabs (33, 34, 35) affixed outwardly are respectively inserted to connect with elastic conduction elements (25A, 25B, 25C) inserted individually by an insulating sleeve (26) to penetrate the through holes (270, 240) respectively disposed on the insulation plate (27) and the press plate (24); then the upper end openings of the conduction elements (25A, 25B, 25C) respectively press and connect with the electrode plates (21A, 21B). The conduction element (25A) penetrates the through holes (240, 270) and a penetrating hole (230) disposed on the fixing plate (23) to conduct with the negative electrode plate (22) such that the negative electricity is completely located on the upper surface of the heat generator (20). The lower surface of he heat generator (20) is divided into two sections by the relative conduction of the electrode plates (21A, 21B); the two sections are respectively conducted by relative conduction elements (25B, 25C) separately connected with the conduction tabs (35, 34).

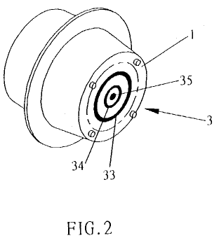

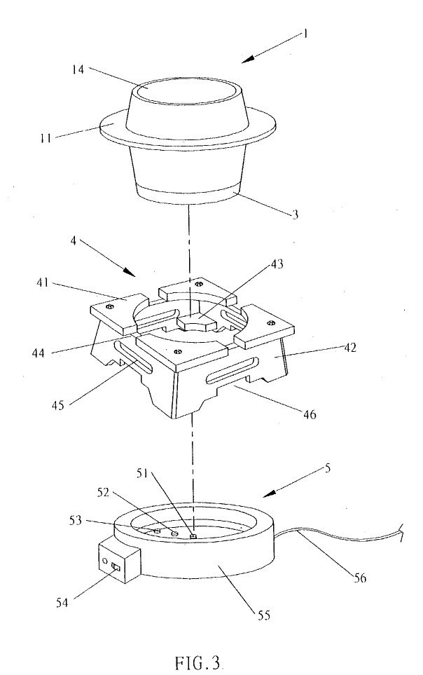

As indicated in FIG. 2, on the outward bottom plane of the bottom tray (3) of the pot (1), a conduction tab (35) is disposed at the center as well as annular conduction tabs (33, 34) are disposed on the outer periphery to form negative electric conduction; the annular conduction tab (34, 35) form selective conduction of the positive power; that means, the input electric power conducts negative power at the annular conduction tab (33) while the positive pole either respectively or synchronously conducts the conduction tab (35) at the center or the annular conduction tab (34) so as to obtain a complete or partially selective electricity conduction of the heat generator (20) thereby forming a three-segmented electricity conduction. The bottom tray (3) of the pot (1) seals the heating device (2) to form a main unit which provides a conduction seat (5) with a plurality of conduction terminals for conducting electric power, as indicated in FIG. 3.

Referring to FIG. 3, the bottom tray (3) of the pot (1) downwardly clips an upper surface of the conduction seat (5). The upper surface of the conduction seat (5) corresponds to the back planes of the conduction tab (33, 34, 35) on the bottom tray (3) shown in FIG. 1 to form conduction terminals (51, 52, 53) for making complete or selective conduction through a switch (54) so as to obtain optional thermal power. The conduction seat (5) is a seat body (55) conducts outwardly with an electric source (56). A grate (4) for supporting is disposed between the pot (1) and the conduction seat (5); the grate (4) is three-dimensional with a round hole formed at the center to correspond to the lower bottom portion of the pot (1); the round hole is defined by shoulder plates (41) disposed on the four directions for receiving the pot (1); holding plates (43) disposed on the bottom portion thereof provide two-pointed supportive holding for the bottom portion of the pot (1) to prevent tilting.

A finger hole (44) is disposed between shoulder plates (41) for inserting a finger to move the pot (1). The grate (4) is formed by lateral plates (42) encircled at the four aspects; a hand hole (45) is disposed respectively on the breadth of the lateral plate (42) for moving the warm pot (1) in operation; a semi open slot (46) is disposed at the position of the switch (54) for inserting in the switch (54); the bottom plane of the seat body (55) and the bottom portion of the grate (4) form the same horizontal plane to allow the upper surface of the conduction seat (5) to butt joint the bottom tray (3) disposed on the pot (1) for heating through electric conduction.

The grate (4) comprises a plurality of shoulder plates (41), lateral plates (42) and holding plates (43). They are made of wood for the purpose of insulating the heat; since the parts are small blocks, they are made of wasted wood. The composition of a plurality of blocks allows the finger holes (44) to form between the shoulder plates (41) for moving the pot (1) conveniently and allows the disposition of the hand holes (4) for moving the heated pot (1) easily thereby achieving the effect of having a full usage, convenient application and protective facility. The shoulder plates (41) are disposed at the upper aspects of the grate (4) and the holding plates (43) are disposed at the lower aspects thereof; the straight lines formed between two plates (41, 43) hold the pot (1) to prevent wobbling. A pot lid (not shown) is disposed at the upper aspect of the pot (1) for covering.

Since the pot (1) is made of metal, the inner surface thereof has capillarity; a filling layer (14), for example, a layer of Teflon capable of removing the capillarity is applied therof, as indicated in FIG. 1. According to the embodiment of the present invention, since the applied heating element is composed by a porcelain resistance with a positive temperature between 250° C. and 280° C., the Teflon filling layer (14) won't cause damage.

Usually, to apply a layer of Teflon on a pot achieves a stain-proof effect; during manufacturing, it is necessary to spray that layer onto the surface of the pot and burn it at a high temperature at about 780° C. for hardening to achieve the adhesion effect. The Teflon layer exfoliates on a regular pot when the temperature of a gas stove frequently reaches 600° C.; the unit temperature of the pot usually gets close to the high strain temperature of the Teflon thereby easily damaging the Teflon layer. Furthermore, during the cooking procedure, placing food with a normal (lower) temperature into the pot causes Teflon to rapidly cool down such that the tissue of the Teflon layer tends to deteriorate.

However, the temperature generated by the heat generator (20) of the present invention maintains between 250° C. and 280° C.; the heating influence of the high temperature toward the filling layer (14) is far below that for deteriorating the Teflon. Therefore, it won't cause thermal effect to damage the filling layer (14) and relative assembling elements thereby assuring and elongating the useful life of the filling layer (14) of the pot (1) and other elements.

Therefore, with the structural design and application status, the present invention has more advantages and is suitable for business, personal or outdoor use. The electric power to be used for indoor or outdoor application is selected by the electric power of the heat generator (20). Usually, a porcelain resistance with positive temperature coefficient adapting the direct current with lower electric pressure is capable of reaching the required working temperature so as to convenience the outdoor or indoor application.

The present invention uses a sealing method to seal the heating device (2); the bottom tray (3) defines and fastens the heating device (2) so as to prevent falling, obtain a specific waterproof effect and provide convenience for cleansing.

The heating device (2) directly affixes to the bottom portion of the pot (1) such that the hot temperature formed directly heats up the pot (1); the heat generator (20) disposed on the heating device (2) transmits the hot temperature in a working method of automatic supplement and heat conductivity; for example, the working temperature of the side affixed the pot bottom directly penetrates through the bottom portion of the pot (1); the temperature on the other side goes through the heat generator (20) to supplement toward the direction of lower temperature; therefore, the hot temperature makes supplemental transmission by following the direction of lower temperature which is also the heat dissipation direction such that the generated hot temperature transmits completely to the pot (1) for delivering the heat almost comprehensively; the heating device (2) has a function of self-controlling a consistent temperature; that means, it automatically breaks the power after the heat reaches the required temperature.

According to the implementation of the present invention, the heat generating portion can be divided into a plurality of heat generators (20) using different conduction ends (25A, 25B, 25C) to conduct each unit; the switch (54) selectively conducts or provides the electricity synchronously for controlling the power so as to basically achieve the application of conveniently selecting the heat level.

The conduction terminals (51, 52, 53) disposed on the conduction seat (5) can have a safe and hidden design requiring no hand contact and that won't be further described.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A safety structure of a clip-type hot pot, more particularly an electric hot pot with a safety structure to be used for hot pot cooking; it mainly has a pot with a heat device disposed at the bottom portion; the inner portion of the heat device is installed with a plurality of sets of heat generators composed by porcelain resistance with positive temperature coefficient; the outmost portion is sealed by a waterproof bottom tray; a plurality of sets of conduction elements are respectively disposed on the bottom tray opposite the heat generators; the conduction elements outwardly and relatively conduct a plurality of sets of annular conduction tabs for functioning at a plurality of sets of conduction terminals disposed at the upper aspects of a conduction seat; the conduction terminals conduct the electricity through the selection of a switch; that is the main feature of the present invention.

2. The safety structure of a clip-type hot pot according to claim 1, wherein a supporting grate is disposed between the pot and the conduction seat.

3. The safety structure of a clip-type hot pot according to claim 1, wherein the heat generator uses the direct current.
